(19) United States
(12) Patent Application Publication
(10) Pub. No.: US 2012/0223593 A1
(43) Pub. Date: Sep. 6, 2012

(54) POWER RECEIVING DEVICE AND WIRELESS POWER SUPPLY SYSTEM

(75) Inventor: Koichiro KAMATA, Isehara (JP)

(73) Assignee: Semiconductor Energy Laboratory Co., Ltd., Atsugi-shi (JP)

(21) Appl. No.: 13/402,984

(22) Filed: Feb. 23, 2012

(30) Foreign Application Priority Data
Mar. 3, 2011 (JP) 2011-046489

(51) Int. Cl. H02J 17/00

(52) U.S. Cl. 307/104

(57) ABSTRACT

A power receiving device used for wirelessly supplying power from a power supply device using electromagnetic resonance to an electronic apparatus which receives power by electromagnetic induction is provided. The power receiving device includes a first antenna coupled with an antenna of the power supply device by electromagnetic resonance, a second antenna coupled with the first antenna by electromagnetic induction, a load, a switching circuit, a control circuit, and an input device. A signal for selecting switching of the switching circuit is generated in the control circuit in response to a command from the input device. A connection between the second antenna and the load is controlled by switching of the switching circuit in response to the signal.

### BACKGROUND OF THE INVENTION

1. Field of the Invention

The present invention relates to power receiving devices that wirelessly receive power and wireless power supply systems including the power receiving devices.

2. Description of the Related Art

A wireless power supply technique for wirelessly supplying power from a power supply device to a power receiving device by electromagnetic induction has been developed and come into practical use. In recent years, a wireless power supply technique for supplying power by electromagnetic resonance (electromagnetic resonant coupling) that enables long-distance power transmission as compared to a wireless power supply technique for supplying power by electromagnetic induction has attracted attention. Unlike by electromagnetic induction, by electromagnetic resonance, high power transmission efficiency can be maintained even when the transmission distance is several meters, and power loss due to misalignment of an antenna of a power supply device and an antenna of a power receiving device can be reduced.

Patent Document 1 and Non-Patent Document 1 disclose wireless power supply techniques utilizing electromagnetic resonance.

### REFERENCE

Patent Document 1: Japanese Published Patent Application No. 2010-219838.

Non-Patent Document 1: Andre Kurs et al., “Wireless Power Transfer via Strongly Coupled Magnetic Resonances”, Science, Jul. 6, 2007, Vol. 317, pp. 83-86.

### SUMMARY OF THE INVENTION

In electromagnetic resonant wireless power supply disclosed in Patent Document 1 and Non-Patent Document 1, a power supply device and a power receiving device each include two antennas. Specifically, the power supply device includes an antenna to which power is supplied from a power source through a contact and a resonant antenna that is coupled with the antenna by electromagnetic induction. Further, the power receiving device includes an antenna for supplying power to a load through a contact and a resonant antenna that is coupled with the antenna by electromagnetic induction. When the resonant antenna of the power supply device and the resonant antenna of the power receiving device are coupled with each other by magnetic resonance or electric field resonance, power is wirelessly supplied from the power supply device to the power receiving device.

As described above, electromagnetic resonance has advantages over electromagnetic induction in transmission distance, allowable range of misalignment of antennas, and the like. Not only the infrastructure of power supply devices using electromagnetic induction but also the infrastructure of power supply devices using electromagnetic resonance can be promoted. However, many of commercialized wireless power supply electronic apparatuses employ electromagnetic induction, and power is hardly transferred from power supply devices using electromagnetic resonance to electronic apparatuses which receive power by electromagnetic induction. Thus, a user needs to properly use a power supply device using electromagnetic induction and a power supply device using electromagnetic resonance depending on the wireless power supply method of an electronic apparatus. Consequently, operation of power supply becomes complex.

Further, when electromagnetic resonant wireless power supply can be performed at a longer transmission distance, the application range of wireless power supply can be widened.

In view of the foregoing problems, an object of the present invention is to provide a power receiving device used for wirelessly supplying power from a power supply device using electromagnetic resonance to an electronic apparatus which receives power by electromagnetic induction. Alternatively, an object of the present invention is to provide a wireless power supply system or a wireless power supply method, in which a power supply device using electromagnetic resonance wirelessly transfers power to an electronic apparatus which receives power by electromagnetic induction.

Alternatively, an object of the present invention is to provide a power receiving device used for wirelessly supplying power from a power supply device using electromagnetic resonance to an electronic apparatus which receives power by electromagnetic resonance at a longer transmission distance. Alternatively, an object of the present invention is to provide a wireless power supply system or a wireless power supply method, in which the power receiving device is used.

In one embodiment of the present invention, a device for controlling a connection between an antenna and a load is provided in an electromagnetic resonant power receiving device. Specifically, a power receiving device according to one embodiment of the present invention includes a load, an antenna, a switching circuit for controlling a connection between the load and the antenna, and a resonant antenna that is coupled with the antenna by electromagnetic induction.

A resonant antenna of a power supply device using electromagnetic resonance is coupled with the resonant antenna of the power receiving device by magnetic resonance or electric field resonance (hereinafter simply referred to as resonance). Thus, power from the resonant antenna of the power supply device is wirelessly supplied to the resonant antenna of the power receiving device by the coupling.

When the switching circuit is on in the power receiving device, the antenna and the load of the power receiving device are wired to each other (i.e., connected to each other through a contact). Thus, in the power receiving device, power supplied to the resonant antenna of the power receiving device is supplied to the antenna of the power receiving device by electromagnetic induction coupling, and then supplied from the antenna to the load through the contact. The above structure enables wireless power supply from the power supply device using electromagnetic resonance to the load of the power receiving device.

When the switching circuit is off in the power receiving device, the antenna and the load of the power receiving device are electrically isolated from each other, and power supply from the antenna of the power receiving device to the load is stopped. When an antenna of an electronic apparatus which receives power by electromagnetic induction is coupled with the resonant antenna of the power receiving device by electromagnetic induction under the above condition, power can be wirelessly supplied from the power supply device using electromagnetic resonance to the electronic apparatus which receives power by electromagnetic induction through the resonant antenna of the power receiving device. Alternatively, when a resonant antenna of an electronic apparatus which receives power by electromagnetic resonance is coupled with the resonant antenna of the power receiving device by resonance under the above condition, power can be wirelessly supplied from the power supply device using electromagnetic resonance to the electronic apparatus which receives power by electromagnetic induction through the resonant antenna of the power receiving device.

The power receiving device according to one embodiment of the present invention may further include a control circuit that generates a signal for controlling switching of the switching circuit.

In one embodiment of the present invention, with a power receiving device having the above structure, power can be wirelessly supplied from a power supply device using electromagnetic resonance to an electronic apparatus which receives power by electromagnetic induction. Alternatively, in one embodiment of the present invention, a wireless power supply system or a wireless power supply method, in which power is wirelessly supplied from a power supply device using electromagnetic resonance to an electronic apparatus which receives power by electromagnetic induction with the use of a power receiving device having the above structure, can be provided.

Alternatively, in the present invention, power can be wirelessly supplied from a power supply device using electromagnetic resonance to an electronic apparatus which receives power by electromagnetic resonance at a longer transmission distance. Alternatively, in the present invention, a wireless power supply system or a wireless power supply method, in which the power receiving device is used, can be provided.

### BRIEF DESCRIPTION OF THE DRAWINGS

In the accompanying drawings:

FIG. 1 illustrates a structure of a power receiving device;

FIG. 2 illustrates a structure of a wireless power supply system;

FIG. 3 illustrates a structure of the wireless power supply system;

FIG. 4 illustrates a structure of a wireless power supply system;

FIG. 5 illustrates a structure of a wireless power supply system;

FIG. 6 is a flow chart illustrating operation of a wireless power supply system;

FIG. 7 illustrates a structure of a wireless power supply system;

FIGS. 8A and 8B illustrate specific examples of a power receiving device;

FIGS. 9A and 9B illustrate specific examples of a power receiving device; and

FIGS. 10A and 10B illustrate specific examples of a power receiving device.

### DETAILED DESCRIPTION OF THE INVENTION

Embodiments and an example of the present invention will be described in detail below with reference to the drawings. Note that the present invention is not limited to the following description. It will be readily appreciated by those skilled in the art that modes and details of the present invention can be modified in various ways without departing from the spirit and scope of the present invention. The present invention therefore should not be construed as being limited to the following description of the embodiments and the example.

### Embodiment 1

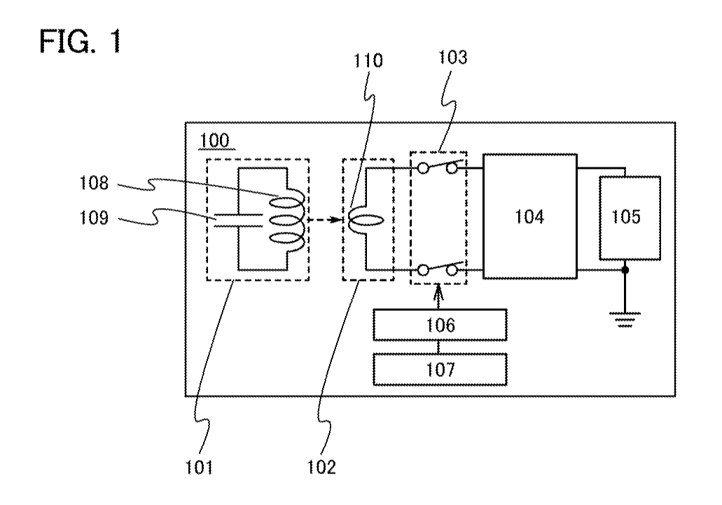

FIG. 1 illustrates the structure of a power receiving device according to one embodiment of the present invention. A power receiving device 100 in FIG. 1 includes a resonant antenna 101, an antenna 102, a switching circuit 103, a rectifier circuit 104, a load 105, a control circuit 106, and an input device 107.

The resonant antenna 101 includes an antenna element 108 that is an inductor. The antenna element 108 has inductance and parasitic capacitance. In order to adjust the resonant frequency of the resonant antenna 101, a capacitor may be connected to the antenna element 108 in addition to the parasitic capacitance in the antenna element 108. In FIG. 1, the parasitic capacitance in the antenna element 108 and the capacitor for adjusting the resonant frequency are collectively referred to as a capacitor 109. The resonant antenna 101 is shown in an equivalent circuit in which the antenna element 108 and the capacitor 109 are connected to each other.

The antenna element 108 can be a spiral conductor, a loop conductor, a helical conductor, or the like. The inductance of the antenna element 108 and the capacitance of the capacitor 109 are set so that the resonant frequency of the resonant antenna 101 is equal to the resonant frequency of a resonant antenna of a power supply device.

The antenna 102 includes an antenna element 110 that is an inductor. As in the antenna element 108, parasitic capacitance exists in the antenna element 110 or an additional capacitor may be connected to the antenna element 110. Further, as in the antenna element 108, the antenna element 110 can be a spiral conductor, a loop conductor, a helical conductor, or the like. Note that in the antenna 102, the shape (e.g., diameter) of the antenna element 110 and the positional relationship between the antenna element 108 and the antenna element 110 are set so that the magnitude of magnetic flux that is output from the resonant antenna 101, is interlinked with the antenna 102, and contributes to induced electromotive force in the antenna 102, that is, the magnitude of main magnetic flux increases. Specifically, it is preferable that the diameter of the antenna element 110 be larger than a distance between the antenna element 108 and the antenna element 110 in order to improve power transmission efficiency between the resonant antenna 101 and the antenna 102.

The switching circuit 103 can control a connection between the antenna 102 and the load 105. Specifically, FIG. 1 illustrates the case where the rectifier circuit 104 is provided between the antenna 102 and the load 105 and a connection between the antenna 102 and the rectifier circuit 104 is controlled by the switching circuit 103.

A pair of power supply points of the antenna 102 is connected to the rectifier circuit 104 through different contacts. FIG. 1 illustrates the case where a connection through two contacts is controlled by the switching circuit 103. Note that in the case where a ground potential is applied to one of the pair of power supply points of the antenna 102, the switching circuit 103 needs to control at least a connection between the other power supply point and the rectifier circuit 104.

Switching of the switching circuit 103 is performed in response to a signal for selecting switching that is transmitted from the control circuit 106. In the case where power is wirelessly supplied from the power supply device to the power receiving device 100, the switching circuit 103 is turned on in response to a signal from the control circuit 106, so that the antenna 102 and the rectifier circuit 104 are connected to each other. In the case where wireless power supply from the power supply device to the power receiving device 100 is stopped, the switching circuit 103 is turned off in response to a signal from the control circuit 106, so that the antenna 102 and the rectifier circuit 104 are electrically isolated from each other.

The signal is generated in the control circuit 106 in response to a command input from the input device 107. A command may be input from the input device artificially. Alternatively, a device for detecting a distance between another electronic apparatus and the power receiving device 100 may be provided in the input device so that a command may be input from the input device in accordance with the distance.

The rectifier circuit 104 rectifies AC power input through the switching circuit 103 and supplies the rectified AC power to the load 105.

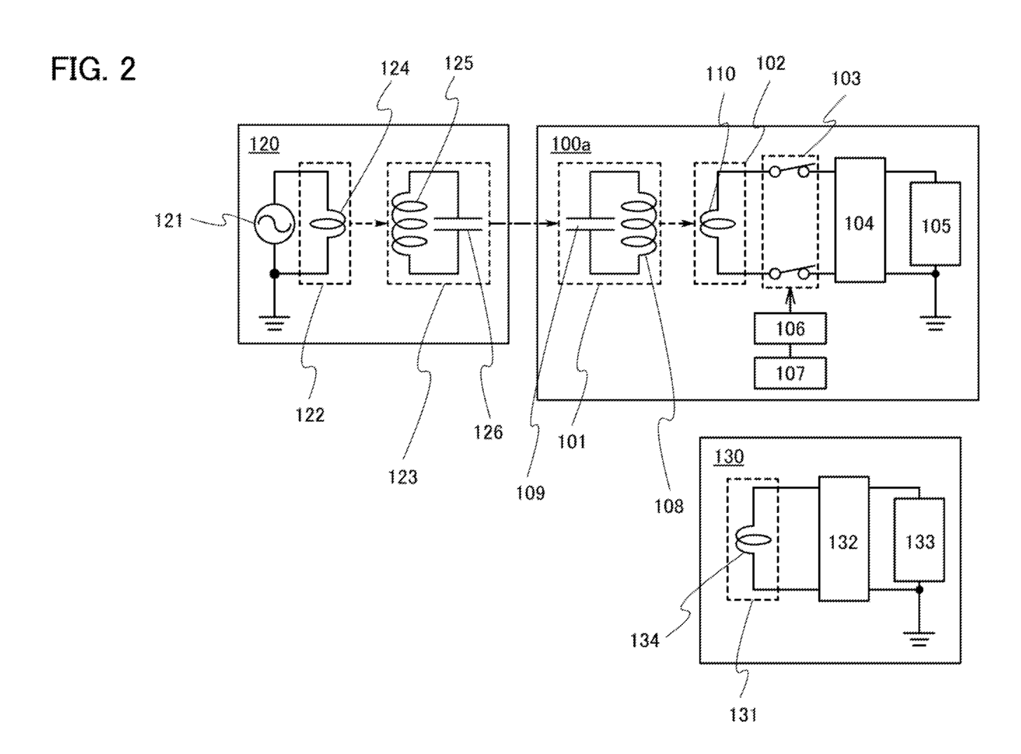

FIG. 2 illustrates an example of a wireless power supply system according to one embodiment of the present invention. The wireless power supply system in FIG. 2 includes a power supply device 120, a first power receiving device 100a, and a second power receiving device 130 that is an electronic apparatus which receives power by electromagnetic induction. The first power receiving device 100a has a structure that is similar to the structure of the power receiving device 100 in FIG. 1.

The power supply device 120 is a power supply device using electromagnetic resonance and includes an AC source 121, an antenna 122, and a resonant antenna 123.

As in the resonant antenna 101, the resonant antenna 123 includes an antenna element 125 that is an inductor. The antenna element 125 has inductance and parasitic capacitance. In order to adjust the resonant frequency of the resonant antenna 123, a capacitor may be connected to the antenna element 125 in addition to the parasitic capacitance in the antenna element 125. In FIG. 2, the parasitic capacitance in the antenna element 125 and the capacitor for adjusting the resonant frequency are collectively referred to as a capacitor 126. The resonant antenna 123 is shown in an equivalent circuit in which the antenna element 125 and the capacitor 126 are connected to each other.

As in the antenna element 108, the antenna element 125 can be a spiral conductor, a loop conductor, a helical conductor, or the like. The inductance of the antenna element 125 and the capacitance of the capacitor 126 are set so that the resonant frequency of the resonant antenna 123 is equal to the resonant frequency of the resonant antenna 101 of the first power supply device 100a.

The antenna 122 includes an antenna element 124 that is an inductor. Parasitic capacitance exists in the antenna element 124 or an additional capacitor may be connected to the antenna element 124. Further, as in the antenna element 125, the antenna element 124 can be a spiral conductor, a loop conductor, a helical conductor, or the like. Note that in the antenna 122, the shape (e.g., diameter) of the antenna element 124 and the positional relationship between the antenna element 125 and the antenna element 124 are set so that the magnitude of magnetic flux that is output from the antenna 122, is interlinked with the resonant antenna 123, and contributes to induced electromotive force in the resonant antenna 123, that is, the magnitude of main magnetic flux increases. Specifically, it is preferable that the diameter of the antenna element 124 be larger than a distance between the antenna element 125 and the antenna element 124 in order to improve power transmission efficiency between the resonant antenna 123 and the antenna 122.

The second power receiving device 130 corresponds to an electronic apparatus that wirelessly receives power from the power supply device 120 through the first power receiving device 100a. FIG. 2 illustrates the case where the second power receiving device 130 is an electronic apparatus which receives power by electromagnetic induction; however, the second power receiving device 130 may be an electronic apparatus which receives power by electromagnetic resonance.

The second power receiving device 130 in FIG. 2 includes an antenna 131, a rectifier circuit 132, and a load 133. The antenna 131 includes an antenna element 134 that is an inductor. Parasitic capacitance exists in the antenna element 134 or an additional capacitor may be connected to the antenna element 134. Further, as in the antenna element 110, the antenna element 134 can be a spiral conductor, a loop conductor, a helical conductor, or the like. Note that in the antenna 131, the shape (e.g., diameter) of the antenna element 134 is set so that the magnitude of magnetic flux that is output from the resonant antenna 101 included in the first power receiving device 100a, is interlinked with the antenna 131, and contributes to induced electromotive force in the antenna 131, that is, the magnitude of main magnetic flux increases. Specifically, it is preferable that the diameter of the antenna element 134 be larger than a distance between the antenna element 108 and the antenna element 134 in order to improve power transmission efficiency between the resonant antenna 101 and the antenna 131.

A pair of power supply points of the antenna 131 is connected to the rectifier circuit 132. The rectifier circuit 132 rectifies AC power input from the antenna 131 and transfers the rectified AC power to the load 133.

Next, wireless power supply from the power supply device 120 to the first power receiving device 100a in the wireless power supply system in FIG. 2 is described. Note that in the wireless power supply system in FIG. 2, the switching circuit 103 included in the first power receiving device 100a is on. In the case where power is wirelessly supplied from the power supply device 120 to the first power receiving device 100a, the switching circuit 103 is kept on, as illustrated in FIG. 2.

In FIG. 2, when AC power is output from the AC source 121 in the power supply device 120, the power is wirelessly supplied to the resonant antenna 123 by electromagnetic induction coupling between the antenna 122 and the resonant antenna 123. Then, the power supplied to the resonant antenna 123 is wirelessly supplied to the resonant antenna 101 by resonant coupling between the resonant antenna 123 and the resonant antenna 101. Further, the power supplied to the resonant antenna 101 is supplied to the antenna 102 by electromagnetic induction coupling between the resonant antenna 101 and the antenna 102. Since the switching circuit 103 is on in the first power receiving device 100a, the power supplied to the antenna 102 is supplied to the rectifier circuit 104 through the switching circuit 103 and is rectified, and then, the rectified power is supplied to the load 105.

Note that in this specification, electromagnetic induction coupling means a state in which power is wirelessly transmitted and received by electromagnetic induction. Similarly, resonant coupling means a state in which power is wirelessly transmitted and received by resonance.

In the wireless power supply system in FIG. 2, in the power supply device 120, the resonant antenna 123 is not in contact with the AC source 121. Further, in the first power receiving device 100a, the resonant antenna 101 is not in contact with the rectifier circuit 104 or the load 105. With the above structure, in the power supply device 120, the resonant antenna 123 can be electrically isolated from the internal resistance of the AC source 121. Furthermore, in the first power receiving device 100a, the resonant antenna 101 can be electrically isolated from the internal resistance of the rectifier circuit 104 or the load 105. Thus, as compared to the case where the resonant antenna 123 is connected to the AC source 121 or the case where the resonant antenna 101 is connected to the rectifier circuit 104 or the load 105, the Q factors of the resonant antenna 123 and the resonant antenna 101 are increased. Consequently, power transmission efficiency can be improved.

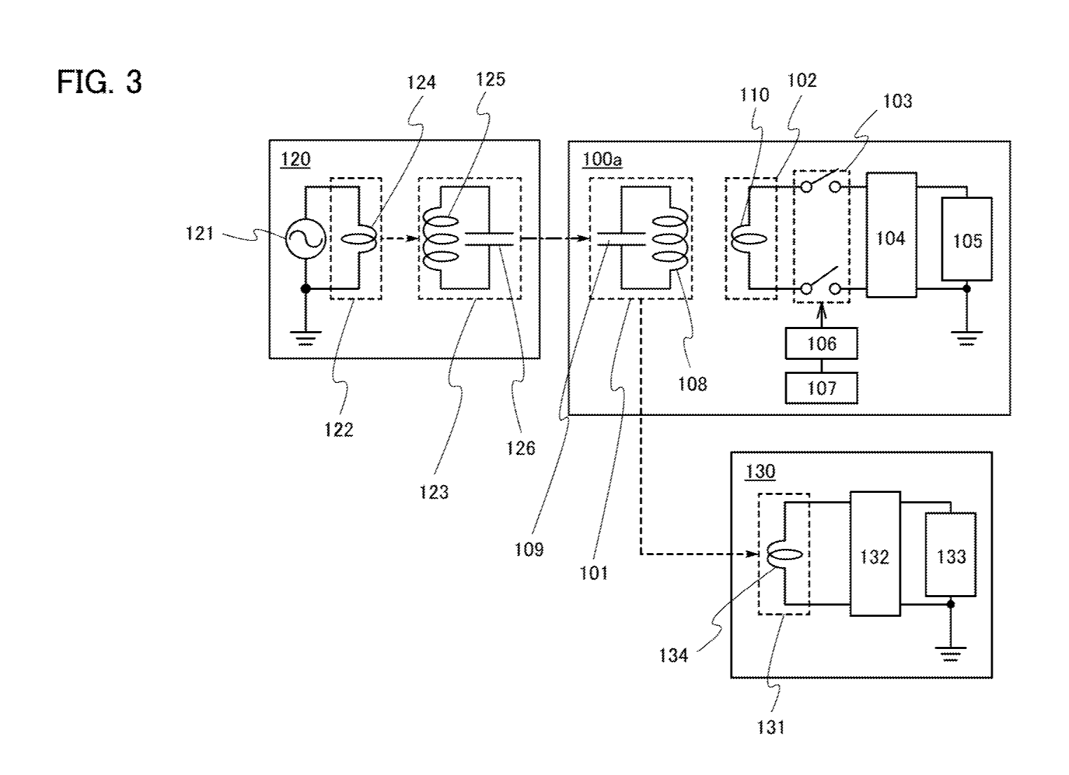

Next, FIG. 3 illustrates a state in which in the wireless power supply system in FIG. 2, the switching circuit 103 included in the first power receiving device 100a is off. In the case where wireless power supply from the power supply device 120 to the first power receiving device 100a is stopped, the switching circuit 103 is kept off, as illustrated in FIG. 3.

In FIG. 3, when AC power is output from the AC source 121 in the power supply device 120, the power is wirelessly supplied to the resonant antenna 123 by electromagnetic induction coupling between the antenna 122 and the resonant antenna 123. Then, the power supplied to the resonant antenna 123 is wirelessly supplied to the resonant antenna 101 by resonant coupling between the resonant antenna 123 and the resonant antenna 101. Note that in the first power receiving device 100a, the switching circuit 103 is off. When the antenna 131 included in the second power receiving device 130 is brought close to the resonant antenna 101 included in the first power receiving device 100a under the above condition, the power supplied to the resonant antenna 101 is supplied to the antenna 131 by electromagnetic induction coupling between the resonant antenna 101 and the antenna 131. The power supplied to the antenna 131 is rectified in the rectifier circuit 132, and then, the rectified power is supplied to the load 133.

Thus, in one embodiment of the present invention, power can be wirelessly supplied from the power supply device 120 using electromagnetic resonance to the second power receiving device 130 which receives power by electromagnetic induction through the resonant antenna 101 included in the first power receiving device 100a.

Note that in one embodiment of the present invention, power can be wirelessly supplied from the power supply device 120 using electromagnetic resonance to the second power receiving device which receives power by electromagnetic resonance through the resonant antenna 101 included in the first power receiving device 100a.

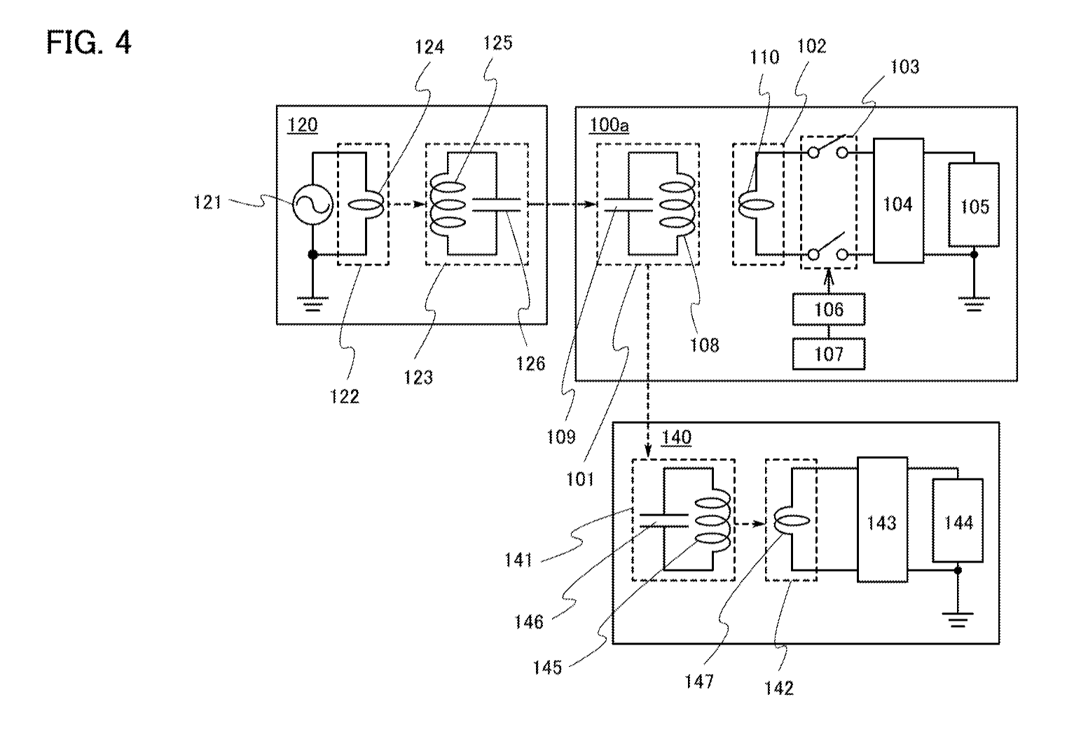

FIG. 4 illustrates an example of a wireless power supply system according to one embodiment of the present invention in wirelessly supplying power from the power supply device 120 using electromagnetic resonance to a second power receiving device 140 which receives power by electromagnetic resonance. The wireless power supply system in FIG. 4 includes the power supply device 120, the first power receiving device 100a, and the second power receiving device 140 that is an electronic apparatus which receives power by electromagnetic resonance.

The second power receiving device 140 includes a resonant antenna 141, an antenna 142, a rectifier circuit 143, and a load 144.

The resonant antenna 141 includes an antenna element 145 that is an inductor. The antenna element 145 has inductance and parasitic capacitance. In order to adjust the resonant frequency of the resonant antenna 141, a capacitor may be connected to the antenna element 145 in addition to the parasitic capacitance in the antenna element 145. In FIG. 4, the parasitic capacitance in the antenna element 145 and the capacitor for adjusting the resonant frequency are collectively referred to as a capacitor 146. The resonant antenna 141 is shown in an equivalent circuit in which the antenna element 145 and the capacitor 146 are connected to each other.

The antenna element 145 can be a spiral conductor, a loop conductor, a helical conductor, or the like. The inductance of the antenna element 145 and the capacitance of the capacitor 146 are set so that the resonant frequency of the resonant antenna 141 is equal to the resonant frequency of the resonant antenna of the power supply device.

The antenna 142 includes an antenna element 147 that is an inductor. As in the antenna element 145, parasitic capacitance exists in the antenna element 147 or an additional capacitor may be connected to the antenna element 147. Further, as in the antenna element 145, the antenna element 147 can be a spiral conductor, a loop conductor, a helical conductor, or the like. Note that in the antenna 142, the shape (e.g., diameter) of the antenna element 147 and the positional relationship between the antenna element 145 and the antenna element 147 are set so that the magnitude of magnetic flux that is output from the resonant antenna 141, is interlinked with the antenna 142, and contributes to induced electromotive force in the antenna 142, that is, the magnitude of main magnetic flux increases. Specifically, it is preferable that the diameter of the antenna element 147 be larger than a distance between the antenna element 145 and the antenna element 147 in order to improve power transmission efficiency between the resonant antenna 141 and the antenna 142.

A pair of power supply points of the antenna 142 is connected to the rectifier circuit 143 through a contact. The rectifier circuit 143 rectifies AC power input from the antenna 142 and transfers the rectified AC power to the load 144.

In FIG 4, when AC power is output from the AC source 121 in the power supply device 120, the power is wirelessly supplied to the resonant antenna 123 by electromagnetic induction coupling between the antenna 122 and the resonant antenna 123. Then, the power supplied to the resonant antenna 123 is wirelessly supplied to the resonant antenna 101 by resonant coupling between the resonant antenna 123 and the resonant antenna 101. Note that in the first power receiving device 100a, the switching circuit 103 is off. When the resonant antenna 141 included in the second power receiving device 140 is brought close to the resonant antenna 101 included in the first power receiving device 100a under the above condition, the power supplied to the resonant antenna 101 is supplied to the resonant antenna 141 by resonant coupling between the resonant antenna 101 and the resonant antenna 141. The power supplied to the resonant antenna 141 is supplied to the antenna 142 by electromagnetic induction coupling between the resonant antenna 141 and the antenna 142. The power supplied to the antenna 142 is rectified in the rectifier circuit 143, and then, the rectified power is supplied to the load 144.

Thus, in one embodiment of the present invention, power can be wirelessly supplied from the power supply device 120 using electromagnetic resonance to the second power receiving device 140 which receives power by electromagnetic resonance through the resonant antenna 101 included in the first power receiving device 100a. Consequently, power can be wirelessly supplied between the power supply device using electromagnetic resonance 120 and the second power receiving device 140 which receives power by electromagnetic resonance at a longer transmission distance through the resonant antenna 101 included in the first power receiving device 100a.

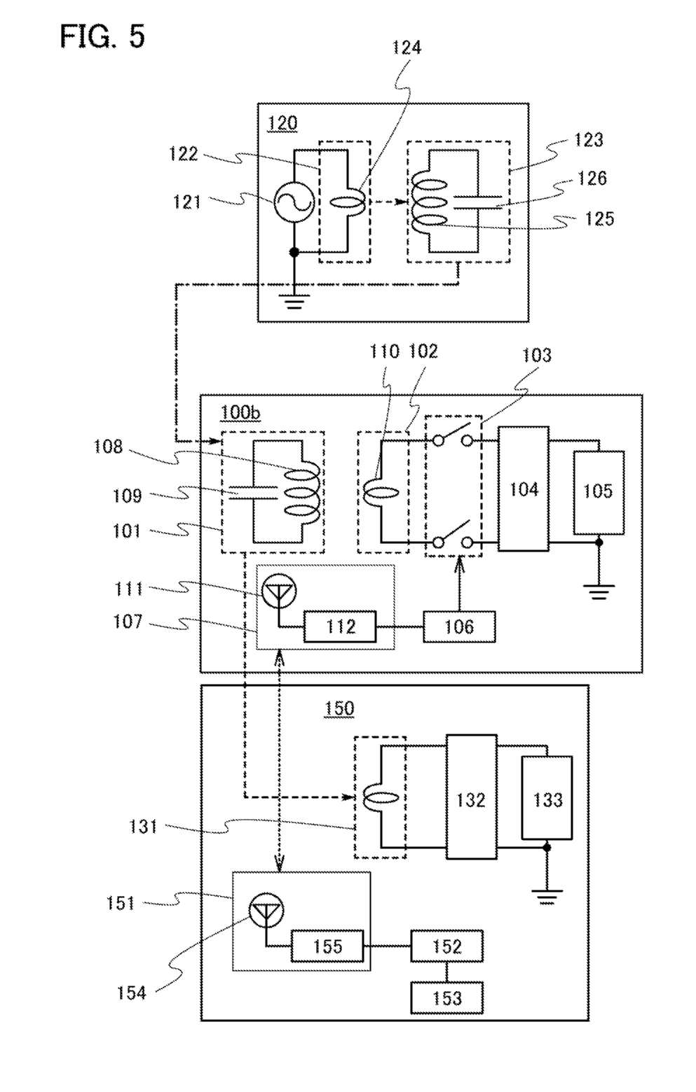

Next, FIG. 5 illustrates another aspect of the power receiving device and the wireless power supply system according to one embodiment of the present invention. The wireless power supply system in FIG. 5 includes the power supply device using electromagnetic resonance 120, a first power receiving device 100b which receives power by electromagnetic resonance, and a second power receiving device 150. the second power receiving device 150 may be either an electromagnetic induction power receiving device or an electromagnetic resonant power receiving device.

As in the first power receiving device 100a in FIG. 2 and FIG. 3, the first power receiving device 100b in FIG. 5 includes the resonant antenna 101, the antenna 102, the switching circuit 103, the rectifier circuit 104, the load 105, the control circuit 106, and the input device 107. Note that in the first power receiving device 100b, the input device 107 includes an antenna 111 and a signal processing circuit 112 that performs signal processing (e.g., rectification, demodulation, or decoding) on a signal received in the antenna 111. The antenna 111 and the signal processing circuit 112 correspond to a device for detecting the positional relationship between the first power receiving device 100b and the second power receiving device 150.

As in the second power receiving device 130 in FIG. 2 and FIG. 3, the second power receiving device 150 includes the antenna 131, the rectifier circuit 132, and the load 133. As in the second power receiving device 140 in FIG. 4, the second power receiving device 150 may further include a resonant antenna.

The second power receiving device 150 in FIG. 5 further includes an output device 151, a control circuit 152, and a storage device 153. The output device 151 includes an antenna 154 and a signal processing circuit 155 that transmits a signal to the antenna 154. The control circuit 152 controls the operation of the signal processing circuit 155. The storage device 153 can store a program executed by the control circuit 152, data used for generation of the signal, and the like. Further, the storage device 153 can temporarily store data obtained during the execution of a program by the control circuit 152.

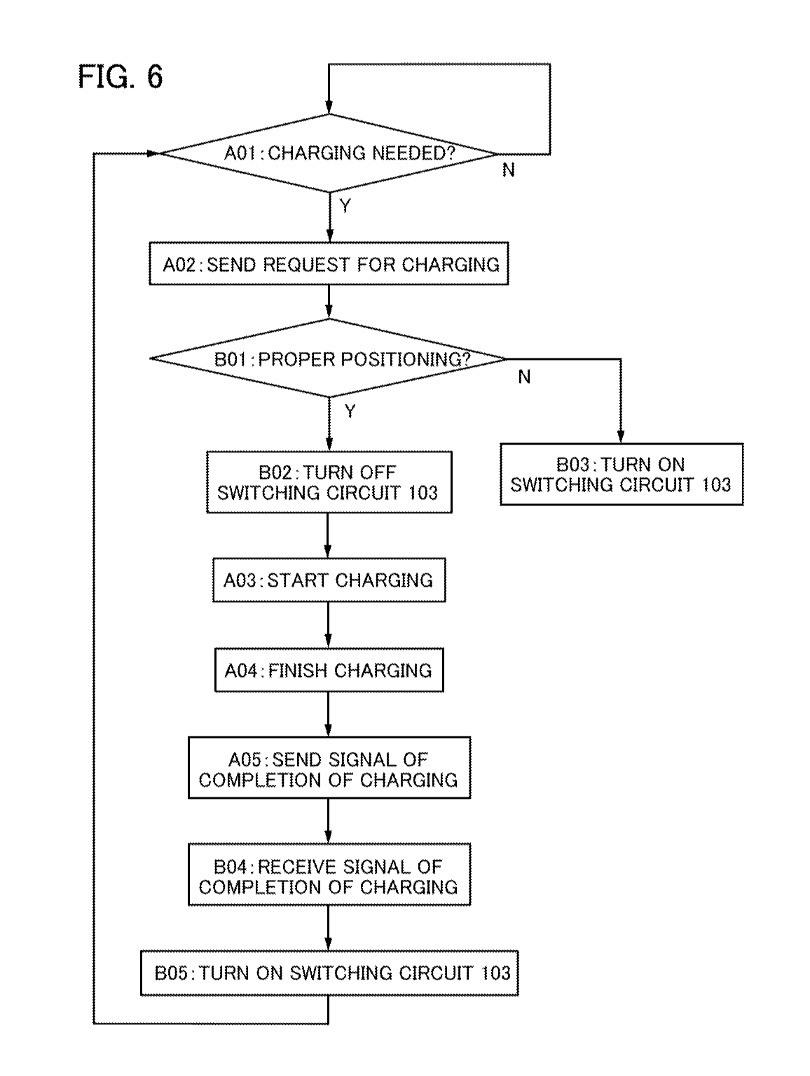

FIG. 6 is a flow chart illustrating an operation example of the wireless power supply system in FIG. 5.

First, the second power receiving device 150 determines whether charging is necessary (A01: CHARGING NEEDED?) from the battery level. When the second power receiving device 150 determines that charging is necessary, an indicator signal for charging is wirelessly transmitted from the output device 151 to the first power receiving device 100b (A02: SEND REQUEST FOR CHARGING).

In the first power receiving device 100b, the signal wirelessly transmitted from the output device 151 in the second power receiving device 150 is received in the antenna 111 in the input device 107. The signal received in the antenna 111 contains data on a positional relationship such as a distance between the first power receiving device 100b and the second power receiving device 150. The signal processing circuit 112 determines whether the positional relationship is suitable for charging by performing signal processing on the signal (B01: PROPER POSITIONING?). Then, when the signal processing circuit 112 determines that the positional relationship is suitable, the signal processing circuit 112 inputs a command to turn off the switching circuit 103 to the control circuit 106. The control circuit 106 turns off the switching circuit 103 in response to the command input from the input device 107 (B02: TURN OFF SWITCHING CIRCUIT 103). When the signal processing circuit 112 determines that the positional relationship is not suitable, the signal processing circuit 112 inputs a command to turn on the switching circuit 103 to the control circuit 106. The control circuit 106 turns on the switching circuit 103 in response to the command input from the input device 107 (B03: TURN ON SWITCHING CIRCUIT 103).

In the case where the switching circuit 103 is off, power is wirelessly supplied from the power supply device 120 to the second power receiving device 150 through the resonant antenna 101 in the first power receiving device 100b. (A03: START CHARGING). After the charging is completed (A04: FINISH CHARGING), in the second power receiving device 150, a signal for notifying the completion of the charging is output from the output device 151 (A05: SEND SIGNAL OF COMPLETION OF CHARGING). After the signal is received in the first power receiving device 100b (B04: RECEIVE SIGNAL OF COMPLETION OF CHARGING), the signal processing circuit 112 performs signal processing on the signal and inputs a command to turn on the switching circuit 103 to the control circuit 106. The control circuit 106 turns on the switching circuit 103 in response to the command input from the input device 107 (B05: TURN ON SWITCHING CIRCUIT 103).

With the above structure, for example, in the case where a distance between the first power receiving device 100b and the second power receiving device 150 is shorter than a specific distance, the switching circuit 103 is turned off, so that power can be wirelessly supplied from the power supply device 120 to the second power receiving device 150 through the resonant antenna 101 in the first power receiving device 100b.

Note that in this specification, although the structures of the power receiving device and the wireless power supply system are described while the rectifier circuit is distinguished from the load, the rectifier circuit can be regarded as a load. Thus, in the case where a switching circuit is provided between the rectifier circuit and the load, even when the switching circuit is off, power is consumed by accumulation of electric charge in capacitance of the rectifier circuit. In one embodiment of the present invention, in order to prevent power consumption in a rectifier circuit, it is preferable to provide a switching circuit between an antenna element and the rectifier circuit in a power receiving device.

### Embodiment 2

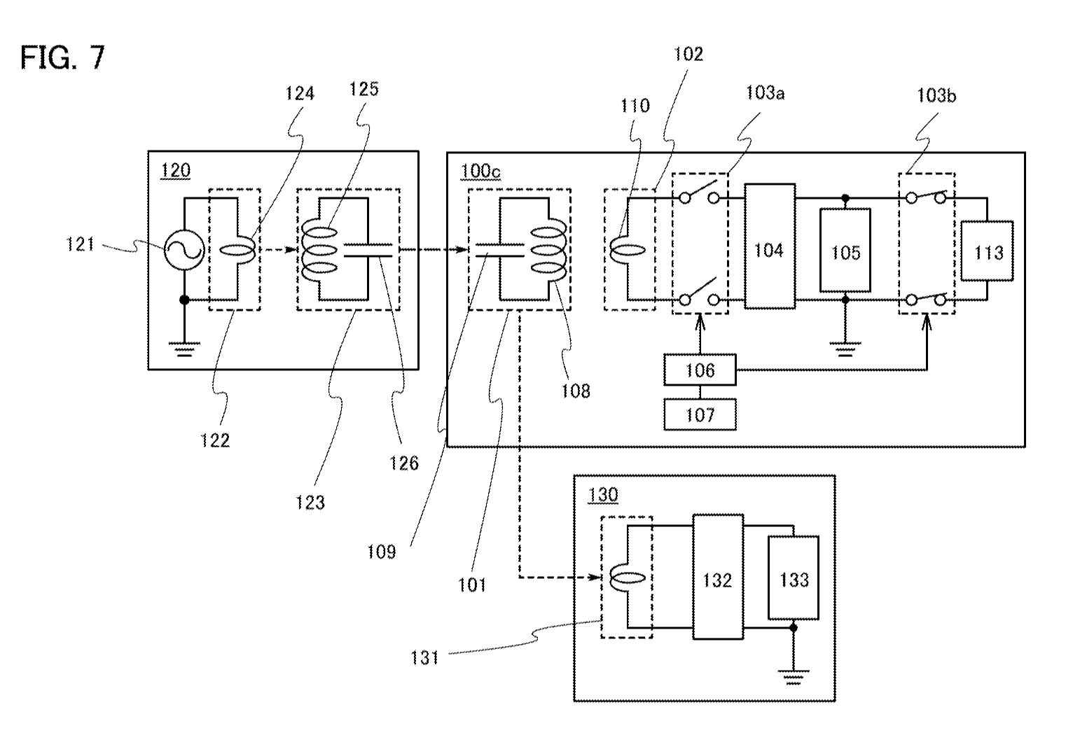

FIG. 7 illustrates an example of a wireless power supply system according to one embodiment of the present invention. The wireless power supply system in FIG. 7 includes the power supply device 120, a first power receiving device 100c, and the second power receiving device 130.

Note that although FIG. 7 illustrates the case where the wireless power supply system includes the second power receiving device 130 that is an electronic apparatus which receives power by electromagnetic induction, the wireless power supply system according to one embodiment of the present invention in FIG. 7 may include the second power receiving device 140 which receives power by electromagnetic resonance in FIG. 4 instead of the second power receiving device 130 which receives power by electromagnetic induction. As in the second power receiving device 150 in FIG. 5, the second power receiving device 130 may include a device for detecting the positional relationship between the first power receiving device 100c and the second power receiving device 130.

As in the first power receiving device 100 in FIG. 1, the first power receiving device 100c includes the resonant antenna 101, the antenna 102, the rectifier circuit 104, the load 105, the control circuit 106, and the input device 107. The first power receiving device 100c further includes a first switching circuit 103a, a second switching circuit 103b, and a secondary battery 113 that is a load.

The first switching circuit 103a can control the connection between the antenna 102 and the load 105. Specifically, FIG. 7 illustrates the case where the rectifier circuit 104 is provided between the antenna 102 and the load 105 and the connection between the antenna 102 and the rectifier circuit 104 is controlled by the first switching circuit 103a.

A pair of power supply points of the antenna 102 is connected to the rectifier circuit 104 through different contacts. FIG. 7 illustrates the case where a connection through two contacts is controlled by the first switching circuit 103a. Note that in the case where a ground potential is applied to one of the pair of power supply points of the antenna 102, the first switching circuit 103a may control at least a connection between the other power supply point and the rectifier circuit 104.

The second switching circuit 103b can control a connection between the load 105 and the secondary battery 113.

Switching of the first switching circuit 103a and the second switching circuit 103b is performed in response to a signal from the control circuit 106. In the case where power is wirelessly supplied from the power supply device 120 to the first power receiving device 100c, the first switching circuit 103a is turned on in response to a signal from the control circuit 106, so that the antenna 102 and the rectifier circuit 104 are connected to each other. Then, in the case where the second switching circuit 103b is on under the above condition, the power from the power supply device 120 is supplied not only to the load 105 but also to the secondary battery 113. Alternatively, in the case where the second switching circuit 103b is off under the above condition, the power from the power supply device 120 is supplied to the load 105 but is not supplied to the secondary battery 113.

In the case where wireless power supply from the power supply device to the first power receiving device 100c is stopped, the first switching circuit 103a is turned off in response to a signal from the control circuit 106, so that the antenna 102 and the rectifier circuit 104 are electrically isolated from each other. Then, in the case where the second switching circuit 103b is on under the above condition, power stored in the secondary battery 113 is supplied to the load 105.

The signal is generated in the control circuit 106 in response to a command input from the input device 107. A command may be input from the input device artificially. Alternatively, a device for detecting a distance between another electronic apparatus and the first power receiving device 100c may be provided in the input device so that a command may be input from the input device in accordance with the distance.

Note that a charging control circuit for preventing overcharging of the secondary battery 113, a constant voltage circuit such as a DC-DC converter, a power supply circuit using a constant voltage circuit, or the like may be connected to the secondary battery 113. In that case, these circuits can be regarded as loads like the secondary battery 113.

This embodiment can be combined with the above embodiment as appropriate.

### EXAMPLE

A power receiving device according to one embodiment of the present invention is an electronic apparatus that can wirelessly receive external power. Specific examples of the power receiving device according to one embodiment of the present invention include display devices, laptops, image reproducing devices provided with recording media (typically, devices which reproduce the content of recording media such as digital versatile discs (DVDs) and have displays for displaying reproduced images), cellular phones, portable game machines, personal digital assistants, e-book readers, cameras such as video cameras and digital still cameras, goggle-type displays (head mounted displays), navigation-systems, audio reproducing devices (e.g., car audio systems and digital audio players), copiers, facsimiles, printers, multifunction printers, automated teller machines (ATM), vending machines, and the like.

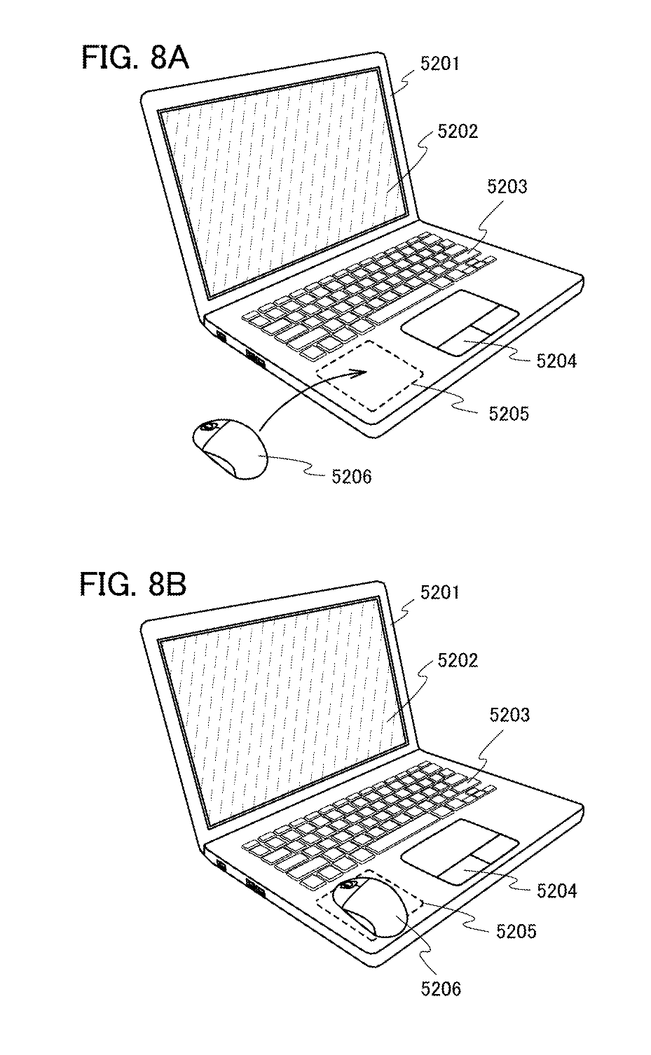

FIG. 8A illustrates a laptop that is a power receiving device according to one embodiment of the present invention. The laptop in FIG. 8A includes a housing 5201, a display portion 5202, a keyboard 5203, a touch pad 5204, a power transmitting and receiving portion 5205, and the like. A resonant antenna of a power receiving device according to one embodiment of the present invention is provided in the power transmitting and receiving portion 5205.

In the laptop in FIG. 8A, power from a power supply device using electromagnetic resonance can be wirelessly received in the power transmitting and receiving portion 5205. Further, the power from the power supply device using electromagnetic resonance can be supplied to an electronic apparatus which receives power by electromagnetic induction or an electronic apparatus which receives power by electromagnetic resonance through the power transmitting and receiving portion 5205.

For example, FIG. 8A illustrates the case where power is supplied to a mouse 5206 that is a pointing device through the power transmitting and receiving portion 5205. In the case where the mouse 5206 receives power by electromagnetic induction, an antenna of the mouse 5206 is brought close to the resonant antenna provided in the power transmitting and receiving portion 5205. Specifically, in FIG. 8A, the mouse 5206 is moved on the power transmitting and receiving portion 5205 of the laptop, as indicated by an arrow.

FIG. 8B illustrates the case where the mouse 5206 is placed on the power transmitting and receiving portion 5205. Under the above condition, power output from the power supply device using electromagnetic resonance can be wirelessly supplied to the mouse 5206 through the power transmitting and receiving portion 5205 in the case where the mouse 5206 receives power by electromagnetic induction. Note that in the case where the mouse 5206 receives power by electromagnetic resonance, unlike the case where the mouse 5206 receives power by electromagnetic induction, the mouse 5206 to be charged is not necessarily placed on the power transmitting and receiving portion 5205. In the case where the mouse 5206 receives power by electromagnetic resonance, by wireless power supply through the power transmitting and receiving portion 5205, a power transmission distance between the power supply device and the mouse 5206 can be increased without a decrease in power transmission efficiency.

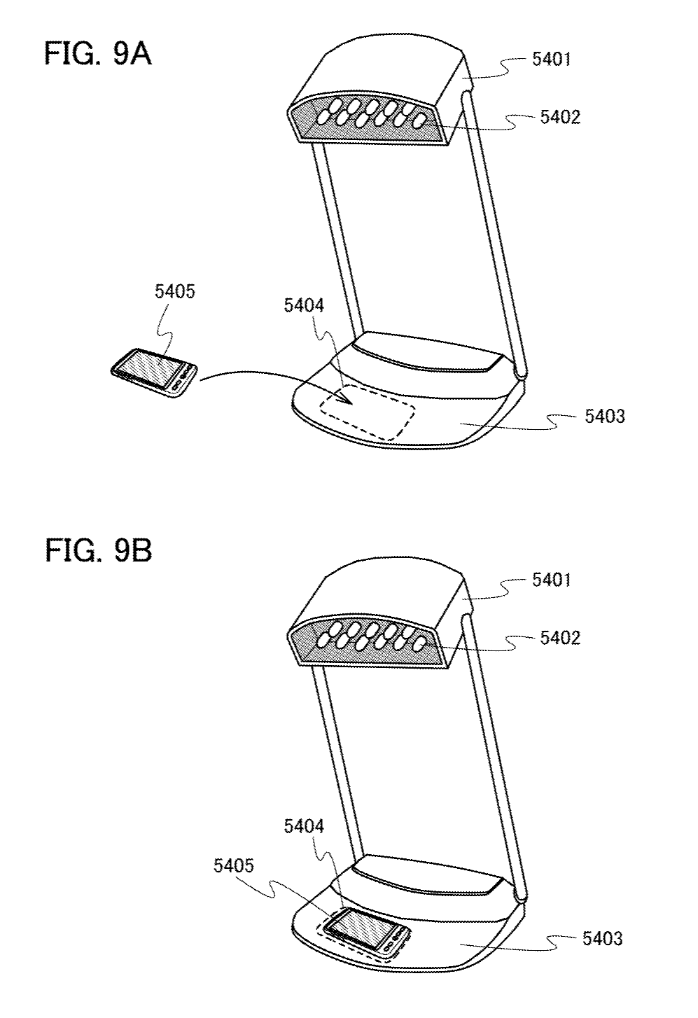

FIG. 9A illustrates a table lighting device that is a power receiving device according to one embodiment of the present invention. The table lighting device in FIG. 9A includes a housing 5401, light sources 5402, a support base 5403, a power transmitting and receiving portion 5404, and the like. A resonant antenna of a power receiving device according to one embodiment of the present invention is provided in the power transmitting and receiving portion 5404. Note that although the power transmitting and receiving portion 5404 is provide on the support base 5403 in the lighting device in FIG. 9A, the power transmitting and receiving portion 5404 can be provided in a portion other than the support base 5403.

In the table lighting device in FIG. 9A, power from a power supply device using electromagnetic resonance can be wirelessly received in the power transmitting and receiving portion 5404. Further, the power from the power supply device using electromagnetic resonance can be supplied to an electronic apparatus which receives power by electromagnetic induction or an electronic apparatus which receives power by electromagnetic resonance through the power transmitting and receiving portion 5404.

For example, FIG. 9A illustrates the case where power is supplied to a smartphone 5405 that is a cellular phone through the power transmitting and receiving portion 5404. In the case where the smartphone 5405 receives power by electromagnetic induction, an antenna of the smartphone 5405 is brought close to the resonant antenna provided in the power transmitting and receiving portion 5404. Specifically, in FIG. 9A, the smartphone 5405 is moved on the power transmitting and receiving portion 5404 of the table lighting device, as indicated by an arrow.

FIG. 9B illustrates the case where the smartphone 5405 is placed on the power transmitting and receiving portion 5404. Under the above condition, power output from the power supply device using electromagnetic resonance can be wirelessly supplied to the smartphone 5405 through the power transmitting and receiving portion 5404 in the case where the smartphone 5405 receives power by electromagnetic induction. Note that in the case where the smartphone 5405 receives power by electromagnetic resonance, unlike the case where the smartphone 5405 receives power by electromagnetic induction, the smartphone 5405 to be charged is not necessarily placed on the power transmitting and receiving portion 5404. In the case where the smartphone 5405 receives power by electromagnetic resonance, by wireless power supply through the power transmitting and receiving portion 5404, a power transmission distance between the power supply device and the smartphone 5405 can be increased Without a decrease in power transmission efficiency.

A power receiving device according to one embodiment of the present invention may be a moving object powered by an electric motor. The moving object is a motor vehicle (a motorcycle or an ordinary motor vehicle with three or more wheels), a motor-assisted bicycle including an electric bicycle, an airplane, a vessel, a rail car, or the like.

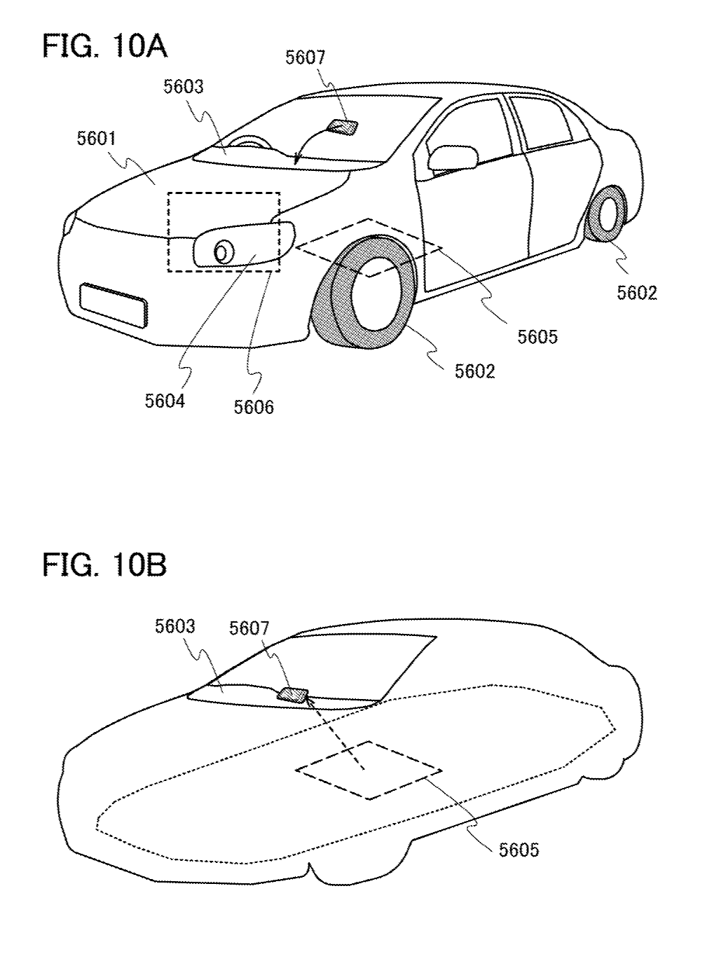

FIG. 10A illustrates an ordinary motor vehicle that is a power receiving device according to one embodiment of the present invention. The ordinary motor vehicle in FIG. 10A includes a car body 5601, wheels 5602, a dashboard 5603, lights 5604, a power transmitting and receiving portion 5605, an electric motor 5606, and the like. A resonant antenna of a power receiving device according to one embodiment of the present invention is provided in the power transmitting and receiving portion 5605. Note that although the power transmitting and receiving portion 5605 is provide at the bottom of the car body 5601 in the ordinary motor vehicle in FIG. 10A, the power transmitting and receiving portion 5605 can be provided in a portion other than the bottom of the car body 5601.

In the ordinary motor vehicle in FIG. 10A, power from a power supply device using electromagnetic resonance can be wirelessly received In the power transmitting and receiving portion 5605. The electric motor 5606 and the lights 5604 correspond to loads and are driven with the power. In the case where the ordinary motor vehicle includes a secondary battery, the power can be stored in the secondary battery. When the electric motor 5606 is driven, the operation of the wheels 5602 can be controlled.

Note that although the ordinary motor vehicle in FIG. 10A uses only the electric motor as a driving motor, the ordinary motor vehicle may use the electric motor and a combustion engine as driving motors. The combustion engine starts to operate when a plug is ignited with power supplied from the power supply device and can control the operation of the wheels 5602.

Further, in the ordinary motor vehicle in FIG. 10A, the power from the power supply device using electromagnetic resonance can be supplied to an electronic apparatus which receives power by electromagnetic induction or an electronic apparatus which receives power by electromagnetic resonance through the power transmitting and receiving portion 5605.

For example, FIG. 10A illustrates the case where power is supplied to a smartphone 5607 that is a cellular phone through the power transmitting and receiving portion 5605. In the case where the smartphone 5607 receives power by electromagnetic resonance, the resonant antenna provided in the power transmitting and receiving portion 5605 is coupled with a resonant antenna of the smartphone 5607 by resonance. Specifically, in FIG. 10A, the smartphone 5607 is moved on the dashboard 5603 of the ordinary motor vehicle, as indicated by an arrow.

FIG. 10B illustrates a state in which the smartphone 5607 is placed on the dashboard 5603. Note that FIG. 10B illustrates the outlines of the ordinary motor vehicle, the dashboard 5603, the power transmitting and receiving portion 5605, and the smartphone 5607 in order to clearly describe the positional relationship between the smartphone 5607 and the power transmitting and receiving portion 5605 in the ordinary motor vehicle.

Under the above condition, power output from the power supply device using electromagnetic resonance can be wirelessly supplied to the electromagnetic resonant smartphone 5607 through the power transmitting and receiving portion 5605. With the above structure, a power transfer distance between the power supply device and the smartphone 5607 can be increased without a decrease in power transmission efficiency.

This example can be combined with any of the above embodiments as appropriate.

This application is based on Japanese Patent Application serial no. 2011-046489 filed with Japan Patent Office on Mar. 3, 2011, the entire contents of which are hereby incorporated by reference.

What is claimed is:

1. A power receiving devise comprising:
a first antenna coupled with an antenna of a power supply device by electromagnetic resonance,
a second antenna coupled with the first antenna by electromagnetic induction;
a load;
a switching circuit; and
an input device,
wherein a connection between the second antenna and the load is controlled by switching of the switching circuit in response to a command from the input device.

2. The power receiving device according to claim 1,
wherein a device for detecting a distance between another electronic apparatus and the power receiving device is provided in the input device, and
wherein the command is input from the input device in accordance with the distance.

3. The power receiving device according to claim 1, further comprising a secondary battery.

4. The power receiving device according to claim 3, further comprising a switching circuit between the load and the secondary battery, wherein the switching circuit is configured to control a connection between the load and the secondary battery.

5. A wireless power supply system comprising:
a first power receiving device including:
a first antenna;
a second antenna;
a load;
a switching circuit; and
an input device; and
a second power receiving device including a third antenna,
wherein the first antenna is coupled with an antenna of a power supply device by electromagnetic resonance,
wherein the second antenna coupled with the first antenna by electromagnetic induction,
wherein the third antenna is coupled with the first antenna by electromagnetic induction, and
wherein a connection between the second antenna and the load is controlled by switching of the switching circuit in response to a command from the input device.

6. The wireless power supply system according to claim 5,
wherein a device for detecting a distance between the first power receiving device and the second power receiving device is provided in the input device, and
wherein the command is input from the input device in accordance with the distance.

7. The wireless power supply system according to claim 5,
wherein the input device comprises a fourth antenna,
wherein the second power receiving device comprises an output device configured to transmit a signal wirelessly, and
wherein the signal is received in the fourth antenna and controls the switching circuit.

8. The wireless power supply system according to claim 5, wherein the first power receiving device further comprises a secondary battery.

9. The wireless power supply system according to claim 8,
wherein the first power receiving device further comprises a switching circuit between the load and the secondary battery, and
wherein the switching circuit is configured to control a connection between the load and the secondary battery.

10. A wireless power supply system comprising:
a first power receiving device comprising:
a first antenna;
a second antenna;
a load;
a switching circuit; and
an input device; and
a second power receiving device comprising a third antenna,
wherein the first antenna is coupled with an antenna of a power supply device by electromagnetic resonance,
wherein the second antenna coupled with the first antenna by electromagnetic induction,
wherein the third antenna is coupled with the first antenna by electromagnetic resonance, and
wherein a connection between the second antenna and the load is controlled by switching of the switching circuit in response to a command from the input device.

11. The wireless power supply system according to claim 10,
wherein a device for detecting a distance between the first power receiving device and the second power receiving device is provided in the input device, and
wherein the command is input from the input device in accordance with the distance.

12. The wireless power supply system according to claim 10,
wherein the input device comprises a fourth antenna,
wherein the second power receiving device comprises an output device configured to transmit a signal wirelessly, and
wherein the signal is received in the fourth antenna and controls the switching circuit.

13. The wireless power supply system according to claim 10, wherein the first power receiving device further comprises a secondary battery.

14. The wireless power supply system according to claim 13,
wherein the first power receiving device further comprises a switching circuit between the load and the secondary battery,
wherein the switching circuit is configured to control a connection between the load and the secondary battery.
